(19) United States
(12) Patent Application Publication
(10) Pub. No.: US 2012/0089385 A1
(43) Pub. Date: Apr. 12, 2012

(54) MEMORY MODELING METHODS AND MODEL GENERATORS

(76) Inventors: Che-Mao HSU, Taichung County (TW); Jen-Chieh YEH, Hsinchu City (TW); Hsun-Lun HUANG, Taichung County (TW)

(21) Appl. No.: 13/072,000

(22) Filed: Mar. 25, 2011

(30) Foreign Application Priority Data
Oct. 12, 2010 (TW) 99134675

(51) Int. Cl. G06F 17/50

(52) U.S. Cl. 703/19

(57) ABSTRACT

A memory modeling method is provided. According to the memory modeling method, a memory model is provided. The memory model includes an array unit, and the array unit includes an array declaration module and a calculation module. A virtual array is defined in a storage device by the array declaration module. The virtual array is configured to simulate a real memory. Further, according to the memory modeling method, an access instruction is received, and an access operation corresponding to the access instruction is performed to the virtual array, wherein the access operation is performed with a transaction level modeling method. Then, an access time or a delay time of the access operation according to the access instruction is estimated by the calculation module.

### CROSS REFERENCE TO RELATED APPLICATIONS

This Application claims priority of Taiwan Patent Application No. 099134675, filed on Oct. 12, 2010, the entirety of which is incorporated by reference herein.

### BACKGROUND OF THE INVENTION

1. Field of the Invention

The invention relates to a memory modeling method, and more particularly to a memory modeling method for performing data transmission with a transaction level modeling method and accurately estimating an access time and a delay time generated when a real memory performs an access operation.

2. Description of the Related Art

Under a globally competitive environment, consumer electronic product life cycles are gradually shortened. In response to user requirements, new products with improved techniques are provided continuously, which greatly increases design complexity of system chip design. In order to get market opportunities, designers of electronic products need a hardware and software integration system in early design stage to increase the entire system efficiency and therefore accelerate the product design cycle.

### BRIEF SUMMARY OF THE INVENTION

An exemplary embodiment of a memory modeling method is provided. The memory modeling method comprises the steps of providing a memory model, wherein the memory model comprises an array unit, and the array unit comprises an array declaration module and a calculation module; and defining a virtual array in a storage device by the array declaration module, wherein the virtual array is configured to simulate a real memory. The memory modeling method also comprises the step of receiving an access instruction and performing an access operation, which corresponds to the access instruction, to the virtual array, wherein the access operation is performed with a transaction level modeling method. The memory modeling method further also comprises the step of estimating an access time or a delay time of the access operation according to the access instruction by the calculation module.

A memory modeling method for handheld devices may take the form of a program code embodied in a tangible media. When the program code is loaded into and executed by a machine, the machine becomes an apparatus for practicing the disclosed method.

An exemplary embodiment of a model generator comprises an estimation generator. The estimation generator generates a memory model according to a memory parameter. The memory model comprises an array unit. The memory parameter is related to a set of parameter of a real memory to be modeled by the memory model. The array unit comprises an array declaration module and a calculation module. According to an access instruction, the array declaration module defines a virtual array and performs an access operation, which corresponds to the access instruction, to the virtual array. The array unit performs the access operation to the virtual array by using a transaction level modeling method. The calculation module estimates an access time and a delay time of the access operation according to the access instruction.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows one exemplary embodiment of a memory model;

FIG. 2 shows another exemplary embodiment of a memory model;

FIG. 3 shows further another exemplary embodiment of a memory model;

FIG. 4 shows an exemplary embodiment of a model generator; and

FIG. 5 shows an exemplary embodiment of a memory modeling method.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

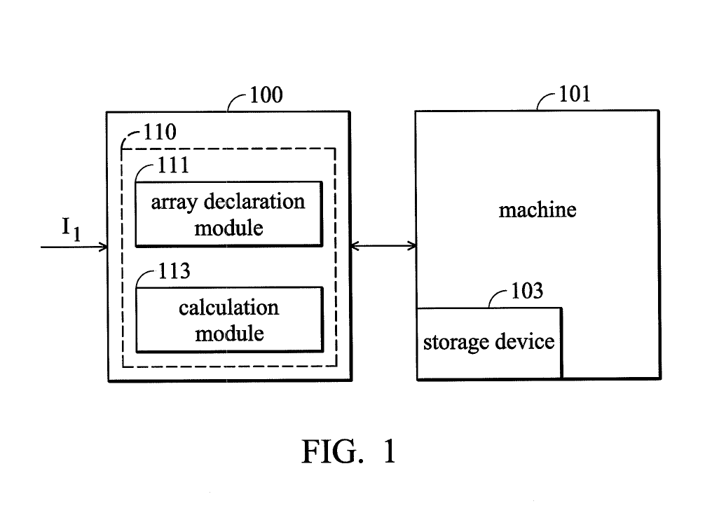

FIG. 1 shows one exemplary embodiment of a memory model. As shown in FIG. 1, a memory model 100 is loaded into a machine 101 to perform a memory modeling method. In the embodiment, the memory model 100 models an access operation of a real memory and accurately estimates a time required for the access operation. In the invention, there is no limitation to the type of the real memory. For example, the memory model 100 may model an SRAM, a DRAM, an EDO DRAM, an SDRAM, a DDR, a DDR2, a DDR3 and so on.

In the embodiment, the memory model 100 comprises an array unit 110. The array unit 110 comprises an array declaration module 111 and a calculation module 113. The array declaration module 111 defines a virtual array in a storage device 103 of the machine 101. According to an access instruction I₁, the array declaration module 111 performs an access operation, which corresponds to the access instruction I₁, for the virtual array. In the embodiment, data transmission is performed to the virtual array in the storage device 103 by using a transaction level modeling method. Thus, the complexity of modeling a memory is decreased, and the simulation speed of the entire virtual platform is enhanced.

According to the access instruction I₁, the calculation module 113 estimates an access time and a delay time of the access operation corresponding to the access instruction I₁. In the invention, there is no limitation to the information implied by the access instruction I₁. In one embodiment, the memory model 100 may be notified of an access address, an operation mode, an access sequence, a time point of an access request, and whether a plurality of access requests overlap according to the access instruction I₁. Thus, the calculation module 113 accurately estimates a real delay time of a real memory to be modeled according to the information implied by the access instruction I₁.

In one embodiment, the array declaration module 111 adjusts the size of the virtual array according to the access instruction I₁. Moreover, the array declaration module 111 obtains the usage of the virtual array (such as the usage of banks) and stores the obtained result in the virtual array.

In one embodiment, the calculation module 113 at least comprises an estimation equation template. The calculation module 113 estimates the access time or the delay time of the real memory under the access instruction I₁ according to the estimation equation template. In another embodiment, the estimation equation template comprises a plurality of time parameters. The time parameters can be adjusted by the access instruction I₁. In the invention, there is no limitation to the types of the time parameters. In one embodiment, the time parameters may be CAL, tRCD, tRP, tRFC, tWR, tREF, tRC, tRR, tRAS and so on.

In the embodiment, the calculation module 113 considers all of delay factors which affect the access time of the real memory, such as time parameters, an operation mode, the type of the real memory to be modeled, a refresh time, an usage status of banks, an access address, an access sequence, and overlapping of access requests. Thus, the calculation module 113 may accurately estimate the real delay time of the real memory to be modeled.

Moreover, to accurately estimate a time required for memory access, in the embodiment, the usage status of the virtual memory at that time is recorded. The usage status comprises a time when each bank is recently accessed, a setting of address mode and various memory time parameters and a record that indicates which banks and rows are currently opened, delays resulting from the plurality of access requests, and whether the last time for memory access was for writing or reading. Via the recorded result, the calculation module 113 may accurately estimate the access time and the delay time which are required when the real memory is accessed. In other embodiments, factors which affect the access time and a delay time of a real memory can be recorded and considered.

In the embodiment, the memory model 100 provides functions of setting parameters, such a function of adjusting memory configurations, a function of adjusting an operation mode, and a function of setting related timing parameters. Thus, only according to the access instruction I₁, the different memory speed levels can be modeled, which provides flexible usage and estimates an operation time of a real memory.

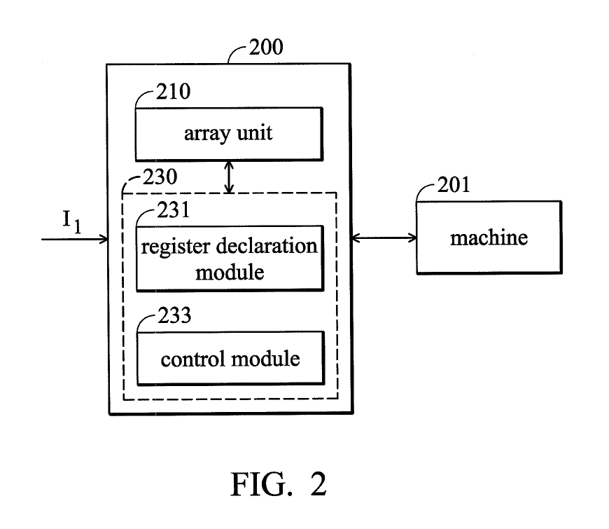

FIG. 2 shows another exemplary embodiment of a memory model. The memory model 200 further comprises a memory controller 230. The memory controller 230 performs data transmission with an array unit 210 by using a transaction level modeling method. In other words, when the memory controller 230 issues an access command to the array unit 210, the array unit 210 immediately provides corresponding burst of data to the memory controller 230 or immediately writes corresponding burst of data into a virtual array.

In the embodiment, the memory controller 230 has a language program, such as C, C++, and SystemC. Moreover, when the memory controller 230 provides the access command to the array unit 210, the array unit 210 also notifies the memory controller 230 an access time and a delay time required when a real memory performs an access operation corresponding to the access command. The memory controller 230 waits for a time period and then outputs an access result according to the time notified by the array unit 210 (the sum of the access time and the delay time).

Since the array unit 210 is similar to the array unit 110 of FIG. 1, the related description is omitted. In the embodiment, the memory controller 230 comprises a register declaration module 231 and a control module 233, however, the invention is not limited thereto. A structure capable of controlling the array unit 210 can be implemented as the memory controller 230.

The register declaration module 231 may be in a storage device of a machine 201 for defining at least one register. In one embodiment, the register declaration module 231 defines at least one first-in-first-output (FIFO) buffer, wherein the number of FIFO buffers and the depth of the FIFO buffer(s) are determined by a memory generator. In another embodiment, the register declaration module 231 adjusts the number of FIFO buffers and the depth of the FIFO buffer(s) according to an access instruction I₁.

The control module 233 provides access information to the array unit 210 according to the information stored in the at least one register (such as the access instruction I₁). The control module 233 can immediately obtain corresponding data and obtain an access time and a delay time of a real memory to be modeled. After the control module 233 waits for a time period (that is the sum of the access time and the delay time), the control module 233 outputs corresponding information.

For memory modeling, the operation frequency and operation mode of the memory controller 230 will also decide an access time of a memory. Thus, an estimation equation template of the array unit 320 may consider delay resulting from the operation frequency and operation mode of the memory controller 230. Moreover, the estimation equation template may also consider a resulting delay time when a plurality of access requests are generated at the same time.

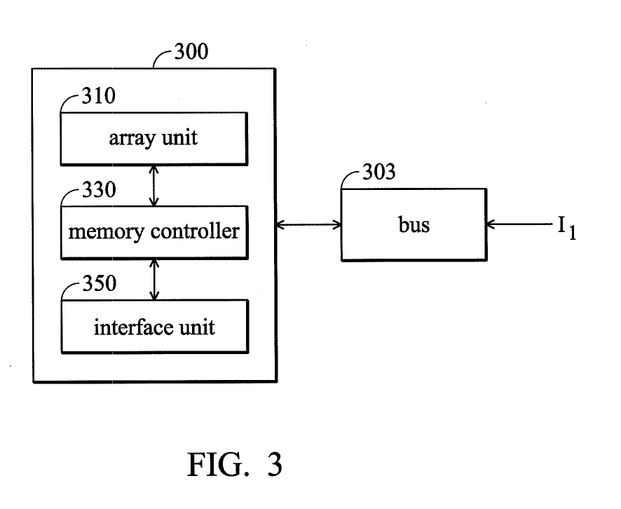

FIG. 3 shows another exemplary embodiment of a memory model. In the embodiment, the memory model 300 further comprises an interface unit 350 which serves as an interface between a memory controller 330 and a bus 303 during data transmission therebetween. Since an array unit 310 and the memory controller 330 of FIG. 3 are similar to the array unit 210 and the memory controller 230 of FIG. 2 respectively, the related description is omitted.

In the embodiment, the interface unit 350 receives an access instruction I₁ through the bus 303 and provides the received access instruction I₁ to the memory controller 330, or the interface unit 350 outputs corresponding data which is obtained by the controller 330 to the bus 303. In the invention, there is no limitation to the type of the interface unit 350. In some embodiments, the interface unit 350 is related to transmission protocols, such as TLM, AXI, AHB, and OCP. In one embodiment, both of the memory controller 330 and the interface unit 350 have a language program, such as C, C++, and SystemC.

In FIG. 3, since the memory model 300 comprises the memory controller 330 and the interface unit 350, a system virtual platform can be established rapidly, and the system virtual platform can support system architecture analysis and exploration. Moreover, in the memory model 300, data transmission between the array unit 310, the memory controller 330, and the interface unit 350 is performed with a transaction level modeling method.

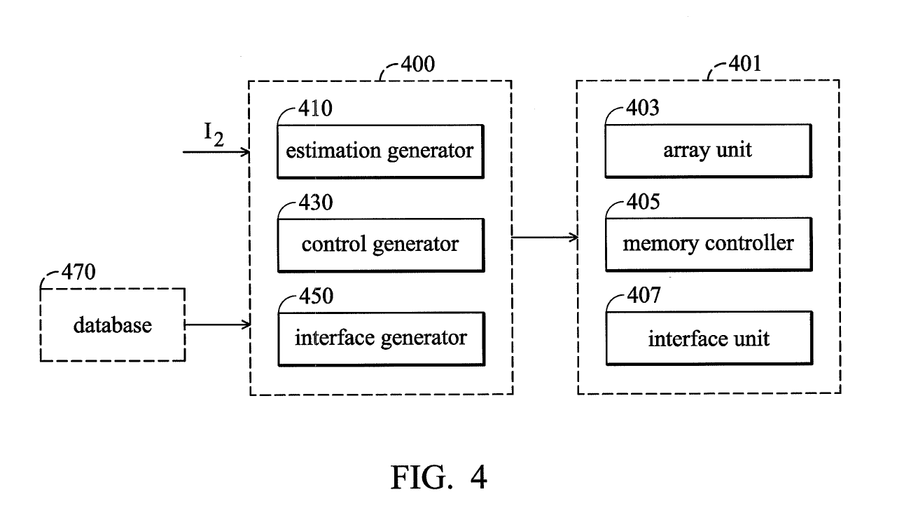

In the invention, there is no limitation to the generation of the memory model. In one embodiment, a memory model is generated by a model generator. FIG. 4 shows an exemplary embodiment of a model generator. In the embodiment, a model generator 400 comprises an estimation generator 410, a control generator 430, and an interface generator 450.

The estimation generator 410 generates an array unit 430 of a memory model 401 according to a memory parameter I₂. The memory parameter I₂ is related to a parameter of a real memory which the memory model 401 is desired to model. For example, when the memory model 401 is desired to model a dynamic random access memory (DRAM), the memory parameter I₂ is related to a memory parameter of the DRAM (such as a time parameter, an operation mode). In the embodiment, the model generator 400 obtains a type of a real memory to be modeled, a time parameter of the real memory, an operation mode, or a refresh time according to the memory parameter I₂.

In one embodiment, the model generator 400 further comprises a database 470. In the embodiment, the database 470 comprises a plurality of time parameters and a plurality of timing equation templates, however, the invention is not limited thereto. The estimation generator 410 retrieves the corresponding parameter and the corresponding timing equation template from the database 470 according to the memory parameter I₂ and then generates the array unit 403 according to the retrieved result.

If the memory model 401 desires to comprise a memory controller, the control generator 430 can be executed to generate the memory controller 405 according to the memory parameter I₂. In one embodiment, the database 470 comprises a plurality of model templates. Thus, the control generator 430 retrieves one model template from the database 470 to serve as the memory controller 405. In another embodiment, the model templates of the database 470 have a C language program, such as C++ and SystemC.

Similarly, if the memory model 401 desires to comprise an interface unit, the interface generator 450 can be executed to generate an interface unit 407 according to the memory parameter I₂. In one embodiment, the database 470 comprises a plurality of interface templates. Thus, the interface generator 450 retrieves one interface template from the database 470 to serve as the interface unit 407. In the embodiment, the interface templates of the database 470 perform data transmission by using a transaction level modeling method.

In the invention, there is no limitation to information implied by the memory parameter I₂. In one embodiment, the memory parameter I₂ notifies a type of a real memory to be modeled (such as DRAM, FLASH and so on), a time parameter (such as CAL, tRCD, tRP, tRFC, tWR, tREF, tRC, tRR, tRAS and so on), and storage capacity (such as the numbers of banks, columns, and rows and bit-width). The above disclosure does not limit the invention. Any parameter which is related to a real memory to be modeled can serve as the memory parameter I₂.

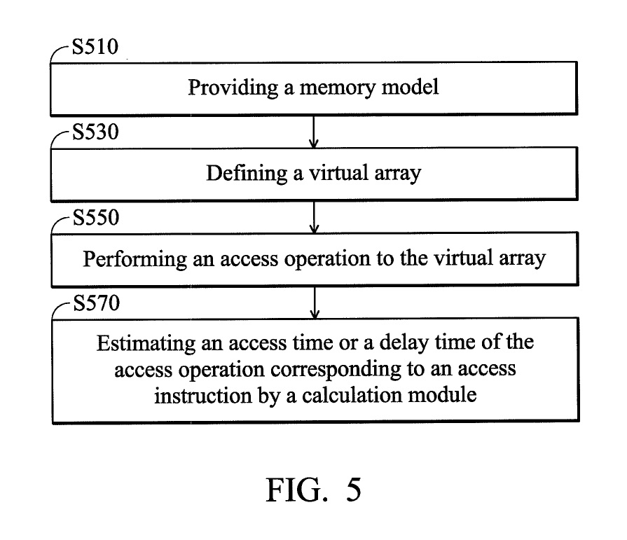

FIG. 5 shows an exemplary embodiment of a memory modeling method. First, a memory model is provided (step S510). In the embodiment, the memory model at least comprises an array unit. The array unit comprises an array declaration module and a calculation module.

The array declaration module is operated to define a virtual array in a storage device (step S530). In the embodiment, the virtual array is used to simulate a real memory.

An access instruction is received, and an access operation corresponding to the access instruction is performed to the virtual array (step S550). In the embodiment, the access operation is performed according to a transaction level modeling method. Moreover, the size of the virtual array can be adjusted according to the access instruction.

According to the access instruction, the calculation module is operated to estimate an access time and a delay time of the access operation corresponding to the access instruction (step S570). In the embodiment, the delay time is related to the access instruction and the memory parameter.

In other embodiments, an access address, an operation mode, an access sequence, a time point of an access request, and whether a plurality of access requests overlap are obtained according to the access instruction. Thus, in the step S570, a real delay time of a real memory to be modeled can be accurately estimated.

In one embodiment, the calculation module comprises at least one estimation equation template. The calculation module estimates the access time or the delay time of the real memory under the access instruction according to the estimation equation template. The estimation equation template is generated according to at least one memory parameter.

In the invention, there is no limitation to the type of the memory parameter. In one embodiment, the memory parameter may comprise a time parameter (such as CAL, tRCD, tRP, tRFC, tWR, tREF, tRC, tRR, tRAS and so on), the type of the real memory to be modeled (such as DRAM, FLASH and so on), and storage capacity (such as the numbers of banks, columns, and rows and bit-width).

In the invention, there is no limitation to the generation of the memory model in the step S510. In one embodiment, the memory model in the step S510 may be generated by the model generator 400 of FIG. 4. In another embodiment, the model generator 400 selects one of a plurality of timing templates according to the memory parameter (such as the type of the real memory) and generates the estimation equation template according to the selected timing template.

In the embodiment, the estimation equation template comprises a plurality of time parameters. The time parameters are determined according to the memory parameter or adjusted according to the access instruction. Moreover, in another embodiment, in order to accurately estimate the time required for memory access, the current memory status is recorded in detail. The status comprises a time when each bank is recently accessed, a setting of address mode and various memory time parameters and a record that indicates which banks and rows are currently opened, delays resulting from the plurality of access requests, and whether the last time for memory access was for writing or reading. Through the recorded result, the access time and the delay time which are required when a real memory is accessed can be accurately estimated.

The memory modeling method, or certain aspects or portions thereof, may take the form of a program code embodied in tangible media, such as floppy diskettes, CD-ROMS, hard drives, or any other machine-readable (such as computer-readable) storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A memory modeling method comprising:
providing a memory model, wherein the memory model comprises an array unit, and the array unit comprises an array declaration module and a calculation module;
defining a virtual array in a storage device by the array declaration module, wherein the virtual array is configured to simulate a real memory;
receiving an access instruction and performing an access operation, which corresponds to the access instruction, to the virtual array, wherein the access operation is performed with a transaction level modeling method; and
estimating an access time or a delay time of the access operation according to the access instruction by the calculation module.

2. The memory modeling method as claimed in claim 1, wherein the calculation module comprises at least one estimation equation template and estimates the access time or the delay time of the access operation according to the estimation equation template, and the at least one estimation equation template is generated according to at least one memory parameter.

3. The memory modeling method as claimed in claim 2, wherein the at least one estimation equation template is generated by a model generator, and the model generator selects one of a plurality of timing templates according to the memory parameter and generates the estimation equation template according to the selected timing template.

4. The memory modeling method as claimed in claim 3, wherein the estimation equation template comprises a plurality of time parameters, and the time parameters are determined according to the memory parameter.

5. The memory modeling method as claimed in claim 3, wherein the delay time is related to the access instruction and the memory parameter.

6. The memory modeling method as claimed in claim 3, wherein the memory model further comprises a memory controller, and the memory controller performs data transmission with the memory unit by using the transaction level modeling method according to the access instruction.

7. The memory modeling method as claimed in claim 6,
wherein the model generator generates the memory controller according to the memory parameter, and the memory controller comprises a register declaration module and a control module,
wherein the register declaration module defines at least one register in the storage device, and a number of registers and a depth of the register are determined by the register declaration module, and
wherein the control module performs the data transmission with the array unit by using the transaction level modeling method according to the information stored in the register.

8. The memory modeling method as claimed in claim 6, wherein the memory model further comprises an interface unit, and the interface unit provides the access instruction to the memory controller for performing the data transmission with the array unit.

9. The memory modeling method as claimed in claim 8, wherein the interface unit and the memory controller comprises a C language program.

10. The memory modeling method as claimed in claim 2, wherein the memory parameter comprises a type of the real memory and storage capacity.

11. The memory modeling method as claimed in claim 1, wherein according to the access instruction, an operation mode, an use status, a refresh time, a plurality of access requests, and a sequence of the access requests of the real memory are obtained.

12. The memory modeling method as claimed in claim 11, wherein the time parameters are adjusted according to the access instruction.

13. A computer program product for being loaded and executed by a computer, comprises:
a first program code providing a memory model, wherein the memory model at least comprises an array unit, and the array unit comprises an array declaration module and a calculation module;
second first program code defining a virtual array in a storage device by the array declaration module, wherein the virtual array is configured to simulate a real memory;
a third program code receiving an access instruction and performing an access operation, which corresponds to the access instruction, to the virtual array, wherein the access operation is performed with a transaction level modeling method; and
a fourth program code estimating an access time or a delay time of the access operation according to the access instruction by the calculation module.

14. A model generator comprises:
an estimation generator generating a memory model according to a memory parameter,
wherein the memory model comprises an array unit, and the memory parameter is related to a parameter of a real memory to be modeled by the memory model,
wherein the array unit comprises an array declaration module and a calculation module,
wherein according to an access instruction, the array declaration module defines a virtual array and performs an access operation, which corresponds to the access instruction, to the virtual array,
wherein the array unit performs the access operation to the virtual array by using a transaction level modeling method, and
wherein the calculation module estimates an access time and a delay time of the access operation according to the access instruction.

15. The model generator as claimed in claim 14 further comprising:
a database comprising a plurality of time parameters and a plurality of timing equation templates,
wherein the estimation generator retrieves the corresponding time parameter and the corresponding timing equation template from the database according to the memory parameter and generates the array unit according to the retrieved result.

16. The model generator as claimed in claim 14 further comprising:
a control generator generating a memory controller in the memory model according to the memory parameter, wherein the memory controller comprises a register declaration module and a control module,
wherein the register declaration module defines at least one register, and a number of registers and a depth of the registers are determined by the register declaration module, and
wherein the control module performs data transmission with the array unit by using a transaction level modeling method according to information stored in the register.

17. The model generator as claimed in claim 16 further comprising:
an interface generator generating an interface unit in the memory model according to the memory parameter,
wherein the interface unit receives the access instruction through an external bus and provides the received access instruction to the memory controller.
